(19) United States
(12) Patent Application Publication
(10) Pub. No.: US 2005/0057810 A1
(43) Pub. Date: Mar. 17, 2005

(54) Diffraction grating

(76) Inventor: Patrick W. Goodwill, Palo Alto, CA (US)

Correspondence Address: CARRIE A. BOONE, P.C., 2450 LOUISIANA, SUITE 400-310, HOUSTON, TX, 77006, US

(21) Appl. No.: 10/662,663

(22) Filed: Sep. 15, 2003

(51) Int. Cl. G02B 26/02

(52) U.S. Cl. 359/573; 359/232

(57) ABSTRACT

Diffraction gratings are disclosed, for use in micro-opto-electro-mechanical (MOEM) applications. The diffraction gratings include movable components that move relative to stationary components, such that square wells are formed for diffracting incident light. The diffraction gratings are capable of horizontal diffraction, vertical diffraction, or diffraction simultaneously in the horizontal and vertical directions.

### FIELD OF THE INVENTION

This invention relates to micro-opto-electro-mechanical (MOEM) devices and, more particularly, to diffraction gratings.

### BACKGROUND OF THE INVENTION

Micro-opto-electro-mechanical (MOEM) light valves are technologies capable of modulating light. These light valves are used in display, printing, and networking applications. Two MOEMs light valves include micromirrors and diffraction gratings.

MOEMs micromirrors modulate light by moving tiny mirrors, such that an image may be projected onto a screen, for example. Micromirrors for display applications may include thousands of tiny, flawlessly-made mirrors, each of which may be individually addressed. Each micromirror controls a single pixel. A micromirror display system may include over two million micromirrors.

MOEMs diffraction gratings, by contrast, modulate light through miniscule changes in morphology, causing changes in diffraction characteristics. Diffraction gratings are composed of repetitive structures, such as slits or wells, on or through which light is diffracted. The repetitive structures may be embodied as multiple beam or ribbon structures, formed from silicon nitride, or similar material, and are arranged such that slits or wells are formed. Positioned above a substrate, the beams are actuated by electrical circuitry within the substrate. When this happens, an electric field pulls dual-end supported beams toward the substrate, producing diffraction wells.

Because the beams are typically fixably attached to a structure at each end, the usable portion of the diffraction grating, known as its active area, includes less than the entire diffraction grating structure. Pixels, which are located within the active area, may be individually activated by electrostatically attracting selected beams of the diffraction grating. This deflection produces a square well diffraction grating for each pixel.

A square well is a physical structure that causes light to be diffracted when the light interacts with the square well surfaces. (Whether rectangular, square, or uniquely shaped, the structure is still known as a square well.) The square well is composed of alternating movable surfaces, such as beams or ribbons, with the moving surface being at the bottom of the well while the non-moving surface is adjacent to the moving surface, or vice-versa. These alternating surfaces are parallel and adjacent to one another, but move orthogonally, in a distance equal to the depth of the well. When alternating beams are pulled toward the substrate, the square wells are formed.

Diffraction gratings have a multitude of square wells, each of which may diffract light. For a given wavelength of light, the dimensions of the square wells can be derived using a square well equation, according to known principles of optics. Optionally, the square well surfaces of the diffraction grating may be coated with a reflective material, such as aluminum, such that the incoming light is reflected off the diffractive surface.

The resonance frequency of a diffraction grating imposes an upper limit on the operating frequency of the beams, since the beams cannot actuate and de-actuate faster than they can vibrate. Generally, diffraction gratings with shorter beams have a higher maximum operating frequency than those with longer beams. However, longer beams are characterized by a more linear change in distance along the bending surface of the beam for a given actuation voltage. Because shorter beams have a stronger restoring force and, thus, a higher resonance frequency than longer beams, diffraction gratings with shorter beams (when built with like materials) tend to be operable at higher speeds.

Digital diffraction gratings employ pulse width modulation to generate intermediate signal intensities between an “off” and an “on” position. When alternating beams of the digital diffraction grating are in an “off” position, the surface of the diffraction grating is substantially flat and reflective. When in an “on” position, the beams may contact the substrate (or an underlying barrier). Physical contact may result in undesirable stiction between the beams and the substrate. Stiction may cause failure and is difficult to model because it is hysteretic.

Analog diffraction gratings typically employ longer beams than digital diffraction gratings. Alternate beams within the grating deflect to positions between “off” and “on,” thus generating intermediate signal intensities, without pulse width modulation. Since no physical contact with a substrate or other underlying barrier occurs, analog diffraction gratings do not experience stiction during normal operation.

Analog diffraction gratings may operate more quickly than digital diffraction gratings. Because pulse width modulation in a digital diffraction grating is used to generate signal intensities between the “off” and “on” states, the pixels of digital diffraction gratings have insufficient speed for many applications. In display technologies, for example, digital diffraction gratings do not change fast enough to raster across a screen. In contrast, the analog diffraction gratings operate at higher frequencies because only one transition is required for each pixel, and so, for many applications, analog diffraction gratings are preferred.

Most diffraction gratings employ perpendicular-to-beam diffraction, i.e., diffraction in a direction perpendicular to the long beam of the diffracting device. Parallel-to-beam diffraction, in which diffraction occurs in a direction parallel to the long beam, is not currently available.

Thus, there is a continuing need to offer a diffraction grating that overcomes the shortcomings of the prior art.

### BRIEF DESCRIPTION OF THE DRAWINGS

For a more complete understanding of the invention, reference is made to the following descriptions taken in connection with the accompanying drawings in which:

FIG. 1 is a perspective view of a diffraction grating, shown in its active state, according to some embodiments;

FIG. 2 is a perspective view of the diffraction grating of FIG. 1, shown in its non-active state, according to some embodiments;

FIGS. 3A-3C are top views of the diffraction grating of FIGS. 1 and 2, according to some embodiments;

FIG. 4 is a perspective view of a second diffraction grating, shown in its non-active state, according to some embodiments;

FIG. 5 is a perspective view of the diffraction grating of FIG. 4, shown in its active state, according to some embodiments;

FIG. 6 is a side view of the diffraction grating of FIG. 4, shown in both active and reflective states, according to some embodiments;

FIG. 7 is a perspective view of multiple copies of the diffraction grating of FIG. 4, according to some embodiments;

FIG. 8 is a perspective view of a surface of a third diffraction grating, according to some embodiments;

FIGS. 9A-9E are top views of the diffraction grating of FIG. 8, in which various arrangements of blocks are depicted, according to some embodiments;

FIG. 10 is a top view of a Czerny-Turner monochromator mounting using a diffraction grating, according to some embodiments; and

FIG. 11 is a top view of an Ebert-Fastie monochromator mounting using a diffraction grating, according to some embodiments.

### DETAILED DESCRIPTION

In accordance with some embodiments described herein, diffraction gratings are disclosed, for use in micro-opto-electro-mechanical (MOEMs) applications. The diffraction gratings include movable components that move relative to stationary components, such that square wells are formed for diffracting incident light. The diffraction gratings are capable of parallel-to-beam diffraction.

In some embodiments, the diffraction grating includes a movable component made up of one or more long beams and orthogonally disposed short beams. The movable component recesses adjacent to a stationary component, forming square wells for diffraction. The diffraction occurs in a direction parallel to the one or more long beams (parallel-to-beam diffraction).

In some embodiments, the diffraction grating includes a row or a two-dimensional array of adjacently disposed blocks. A square well may be formed for diffraction by actuating alternate blocks of the row or array. When viewed from the top, the diffraction grating may diffract light in a horizontal direction, in a vertical direction, or simultaneously in the horizontal and vertical directions.

In the following detailed description, reference is made to the accompanying drawings, which show by way of illustration specific embodiments in which the invention may be practiced. However, it is to be understood that other embodiments will be come apparent to those of ordinary skill in the art upon reading this disclosure. The following detailed description is, therefore, not to be construed in a limiting sense, as the scope of the present invention is defined by the claims.

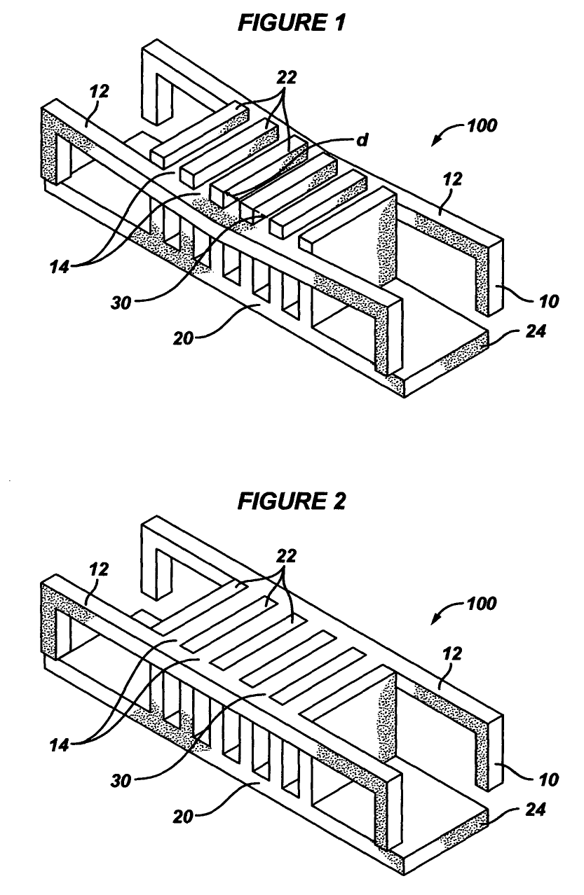

With reference to FIGS. 1, 2, and 3A-3C, a diffraction grating 100, according to some embodiments, is depicted. In FIGS. 1 and 2, a perspective view of the diffraction grating is shown, in which FIG. 1 depicts the active state while FIG. 2 depicts the non-active state. The diffraction grating 100 includes a movable component 10 and a stationary component 20. The movable component 10 recesses relative to the stationary component 20, by bending towards the substrate 26, actuated by electrostatic attraction or repulsion, to form one or more square wells 30.

The movable component 10 includes multiple cross beams 14 sandwiched between two long beams 12, arranged into a ladder-like structure. The cross beams are orthogonal to the long beams. The multiple projecting beams 22 are connected to a substrate 24. The projecting beams 22 are alternately disposed between adjacent cross beams 14.

When a voltage is applied between the substrate 24 and the movable component 10, the movable component 10 is bent slightly at its ends, such that the cross beams 14 are vertically displaced in a downward direction, causing the square wells 30 to be formed. In some embodiments, the vertical displacement of the cross beams 14 occur at a distance up to λ/4 from the top of the stationary component 20, where λ is the wavelength of light. Thus, when the diffraction grating is fully diffractive (FIG. 1), the vertical length of the square well 30 is λ/4. Smaller displacements up to λ/4 reduce the amount of light diffracted.

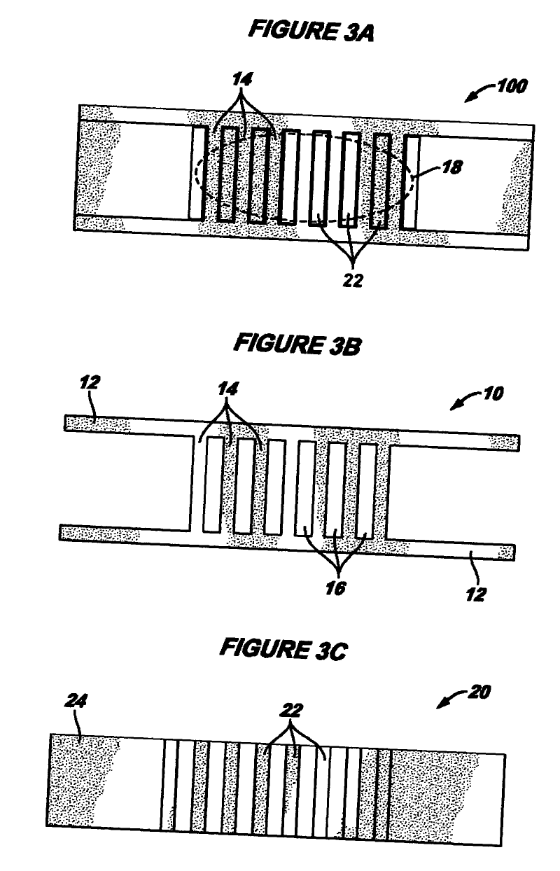

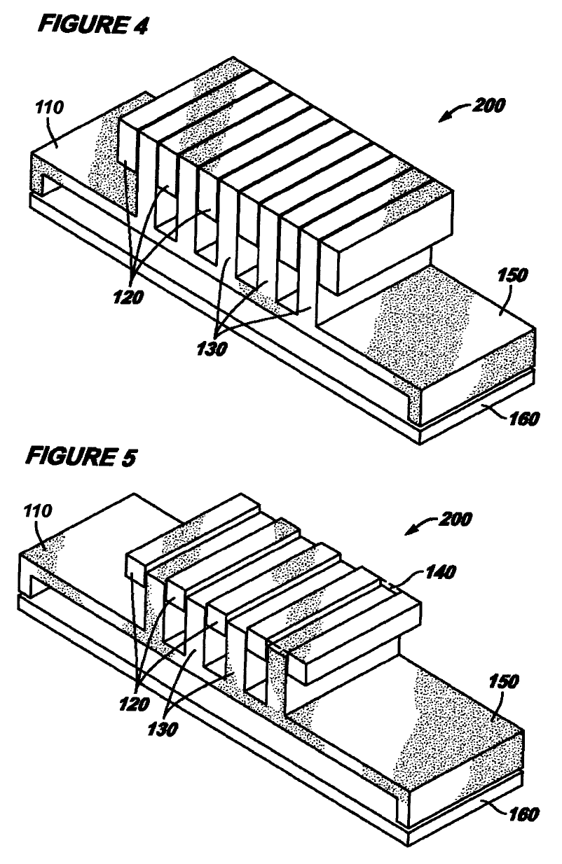

In FIGS. 3A-3C, top views of the diffraction grating 100, the movable component 10, and the stationary component 20, respectively, are depicted. The interconnection of the long beams 12 with the cross beams 14 results in multiple openings 16, through which the projecting beams 22 are disposed. The projecting beams 22 substantially fill the space of yet freely move within the openings 16 such that contact between the projecting beams 22 and the movable component 10 is avoided. However, the space between the projecting beams 22 and the walls of the openings 16 is preferably small.

The active area 18 of the diffraction grating 100 includes multiple projecting beams 22 and multiple cross beams 14. The active area 18 is the usable portion of the diffraction grating 100. The size of the active area may vary, depending on the application or the preferred bandwidth.

Optionally, a portion of the diffraction grating 100 may be coated with a reflective material, such as gold, silver, or aluminum, making the substantially planar surface highly reflective. For example, the projecting beams 22 and the cross beams 14 which make up the active area of the diffraction grating 100 may be coated with a reflecting material. The reflective and conductive metal also operates as a capacitor, to actuate the diffraction grating 100.

In the diffractive (active) state (FIG. 1), the movable component 10 is positioned above the stationary component 20, forming the square well 30. The long beams 12 of the movable component 10 bend slightly when actuated, such that the cross beams 14 move in a downward position, relative to the projecting beams 22 of the stationary component 20. The juxtaposition of the movable component 10 relative to the stationary component 20 creates the square well 30, which allows incident light to diffract in a predictable manner. In the diffraction grating 100, diffraction is parallel to the long beams 12, known herein as parallel-to-beam diffraction.

In some embodiments, the diffraction grating 100 is designed to avoid diffuse reflection. The long beams 12, particularly outside the active area 18 of the diffraction grating 100, may produce light noise. One strategy for avoiding diffuse reflection is to emphasize the 0^{th} order reflection from the long beams 12 by making them wider. Another strategy is to make the surface of the long beams 12 form a diffraction grating perpendicular to the diffraction grating 100.

In the reflective (non-active) state (FIG. 2), the movable component 10 is not actuated, closing the square wells 30. Instead, the projecting beams 22, the long beams 12, and the cross beams 14 form a substantially planar surface, which may be reflective. In other embodiments, the diffraction grating forms square wells when the movable component is not actuated (resting state) while no square wells are present when the movable component is actuated. This could be achieved, for example, by changing the vertical length of the projecting beams 22 in FIG. 1. In still other embodiments, the diffraction grating forms square wells when the movable component is not actuated (resting state), but is disposed such that square wells of vertical height λ/2, which are non-reflective, are formed when actuated.

In some embodiments, both the movable component 10 and the stationary component 20 of the diffraction grating 100 are made of silicon nitride, which has properties suitable for deflecting the movable component. Silicon may be added to the silicon nitride, as desired, to tune the mechanical properties of the dual-end supported beams. Such a change, however, may lower the resonance frequency, which may, in turn, limit the operating speeds of the device. Since silicon nitride is not electrically conductive, the surfaces of the diffraction grating 100 may be coated with a conductive material, such as aluminum, or the silicon nitride could be doped with a material to make it conductive. In other embodiments, all materials of the diffraction grating 100 are composed of silicon.

For a given wavelength of incoming light, the angle of diffraction is dependent on the spacing of the grating, i.e., the dimension of the square well 30, which is based on the dimension of the openings 16. The dimension of each square well 30 can be specified so as to diffract a single color from a light source. Since each color in a spectrum of visible light has a different wavelength, the dimension, d, of the square well 30 can be tailored to diffract a predetermined color at a predetermined angle from the incoming light.

Likewise, the diffraction grating 100 can be tailored to diffract multiple light wavelengths (e.g., multiple colors) simultaneously. This may be achieved by having adjacent beams of the diffraction grating, in which square wells within each beam structure have a particular size, or pitch, but square wells within adjacent beams have a different size.

Returning to FIG. 1, for example, the diffraction grating 100 may have square wells of a first dimension, tuned to diffract blue light, for example. A second diffraction grating, disposed adjacent to the diffraction grating 100, may have square wells of a second dimension, tuned to diffract green light. A third diffraction grating may have square wells of a third dimension, tuned to diffract red light.

Together, the three diffraction gratings form a diffraction grating, which can simultaneously diffract multiple colors. Since the wavelengths of red, green, and blue light are known, the square wells may be calculated such that a specific angle of diffraction of the first diffraction order for the square wells produces blue, green, and red, respectively. Such a diffraction grating may be useful for many applications, such as in display technologies. The concept can be extended to diffract other combinations of color for other applications as well.

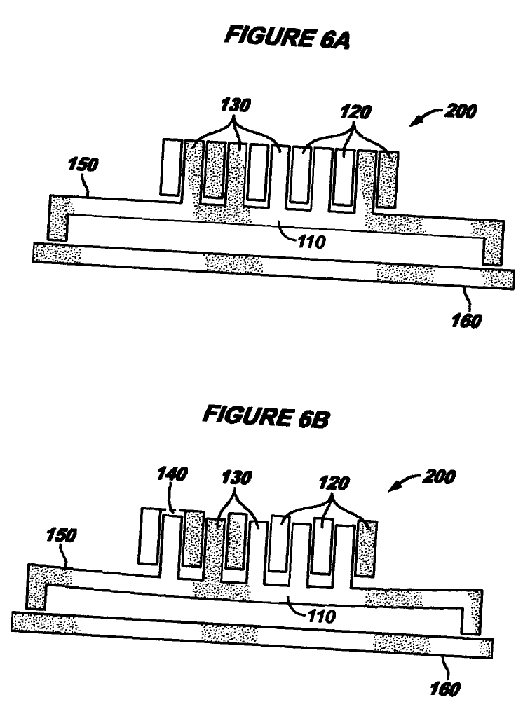

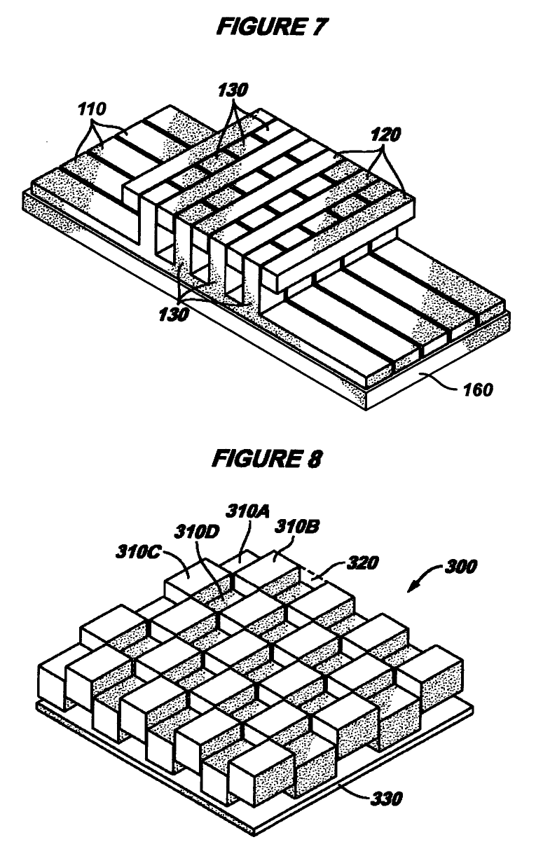

With reference to FIGS. 4-8, a diffraction grating 200, according to some embodiments, is depicted. Like the diffraction grating 100, the diffraction grating 200 includes both static and dynamic components, whose relative movement form square wells suitable for diffraction. FIGS. 4 and 5 are perspective views, FIGS. 6A and 6B are side views, and FIG. 7 is a perspective view showing multiple copies of the diffraction grating 200.

The perspective views of FIGS. 4 and 5 depict the diffraction grating 200 in both its non-active and its active (diffractive) states, respectively. The diffraction grating 200 includes a movable component 110, which includes a long beam 150 and projecting beams 130, disposed over a substrate 160. The projecting beams 130 extend from the long beam 150 and fit between, but remain unattached to, the stationary beams 120. The projecting beams 130 are orthogonal to the long beam 150. Likewise, the stationary beams 120 are orthogonal to the long beam 150, such that the stationary beams are parallel and adjacent to the projecting beams. Although not shown in FIGS. 4 and 5, the stationary beams 120 may be connected together.

In the non-active (resting) state (FIG. 4), the diffraction grating 200 forms a substantially planar surface, having no square wells. The top of the stationary and the projecting beams may be coated with a reflective material, such that, when not actuated, the planar surface is reflective. Like the diffraction grating 100, the diffraction grating 200 can be made from silicon nitride material or pure silicon. Silicon may be added to the silicon nitride, as desired, to increase the flexibility of one or more components of the diffraction grating.

When the diffraction grating 200 is activated (FIG. 5), the long beam 150 flexes such that the connected projecting beams 130 are recessed relative to the stationary beams 120, forming square wells 140. Accordingly, the stationary beams 120 are positioned such that the projecting beams 130 fit snugly between the respective stationary beams without making contact thereto. The tops of the projecting beams 130 and the sides of the stationary beams 120, form the square wells 140. In the diffraction grating 200, diffraction occurs parallel to the long beam 150 of the movable component 110, for parallel-to-beam diffraction.

In other embodiments, the square wells 140 are formed when the diffraction grating 200 is in its non-active (resting) state while a substantially planar surface is formed when in its active state. This may be achieved, for example, by changing the vertical height of the projecting beams 130. In still other embodiments, square wells of vertical height λ/2 are formed when the diffraction grating 200 is in its resting state.

FIGS. 6A and 6B are side views of the diffraction grating 200, in the non-active and the active states, respectively. The long beam 150 is bent to form the square wells 140 when a voltage is applied between the long beam 150 and the substrate 160. The bending of the long beam 150 is exaggerated, for illustrative purposes. Diffraction occurs parallel to the long beam 150 of the diffraction grating 200, for parallel-to-beam diffraction.

The perspective view of FIG. 7 depicts a two-dimensional diffraction surface, including multiple copies of the diffraction grating 200, lined up adjacent to one another. The two-dimensional surface includes multiple rows of movable components 110, in which the projecting beams 130 fit between the respective stationary beams 120 in each row. One or more long beams may be simultaneously actuated by supplying a voltage between the long beams and the substrate 160.

For each movable component 110 that is actuated, a row of square wells 140 is formed. Where alternating movable beams 110 are actuated, diffraction may occur in a direction parallel to the length of the movable component (parallel-to-beam diffraction) and in a direction perpendicular to the movable beam (perpendicular-to-beam diffraction) simultaneously.

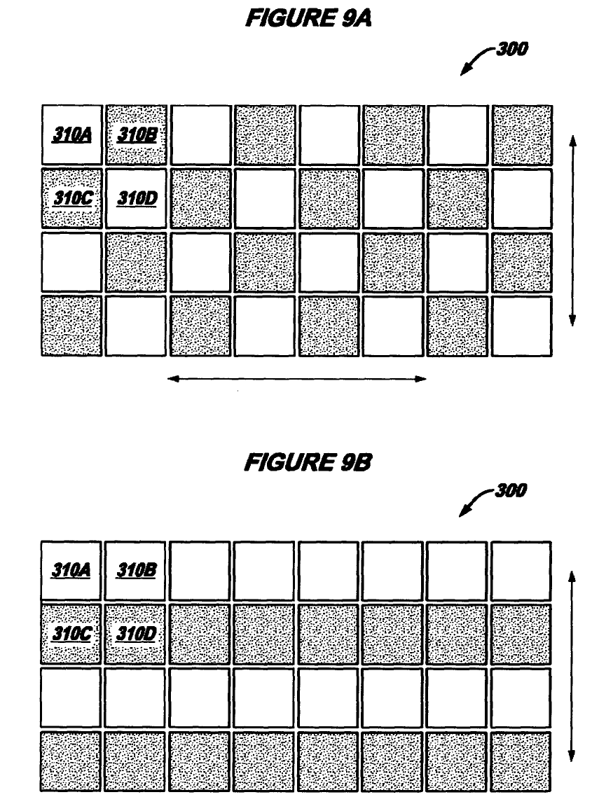

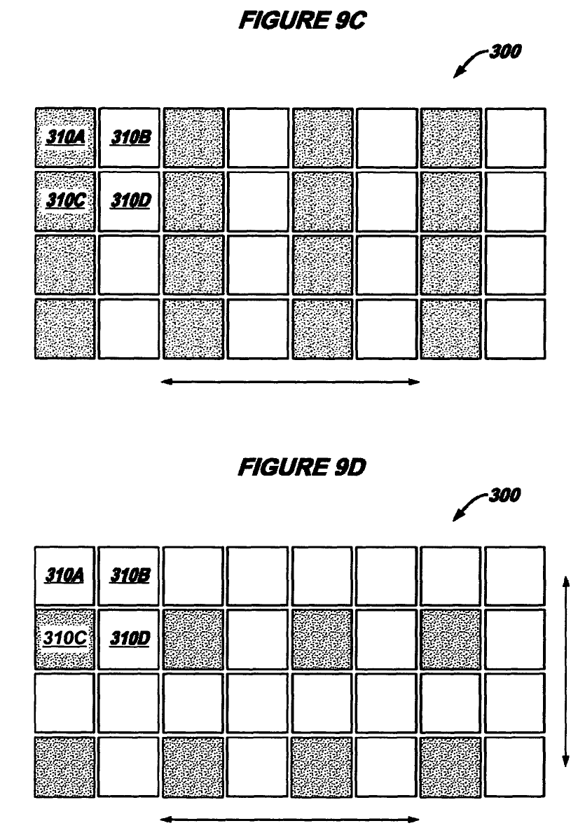

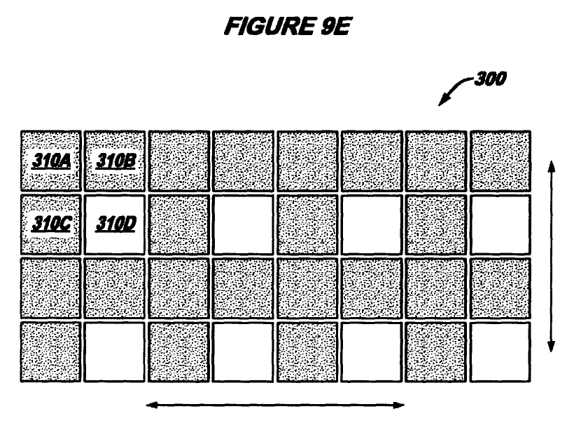

With reference to FIGS. 8 and 9-9E, a diffraction grating 300 is shown, according to some embodiments. FIG. 8 is a perspective view of the diffraction grating 300, including blocks 310A, 310B, 310C, and 310D (collectively, blocks 310). In the diffraction grating 300, a row is a horizontal queue of blocks. The blocks 310 are arranged in 2×2 groups, in which a first row of a group includes blocks 310A and 310B while a second row of the group includes blocks 310C and 310D. The 2×2 groups are repeated multiple times in the diffraction grating 300, as shown.

The blocks 310 are positioned atop a substrate 330, which includes circuitry for electrostatically recessing the blocks toward the substrate. The diffraction grating 300 is a substantially planar surface when none or all of the blocks 310 are actuated. The upper surface of each block 310 may be coated with a reflective material, such as aluminum. The upper surface of each block 310 is square in shape, so that the diffraction grating 300 can diffract light in two directions simultaneously.

Because the blocks 310 are adjacent to one another, actuating alternating blocks toward the substrate results in the formation of a square well 320, from which diffraction can occur. In FIG. 8, the blocks 310A and 310D are recessed or actuated to form square wells 320. In some embodiments, the square wells 320 are λ/4 in height, although other arrangements are possible.

By producing a voltage between a block and the substrate 330, the block moves toward the substrate, creating the square well 320. The blocks 310 may be controlled independent of one another, for example, by each having their own enabling circuitry. Or, connectors may be attached to alternating blocks, as long as interference with block movement or light transmission is avoided. Connectors between blocks allow alternate blocks in a row to be simultaneously moved, as in FIG. 8. As another option, corresponding blocks may be interconnected, such that all of the blocks 310A, for example, are simultaneously recessed.

In some embodiments, the diffraction grating 300 is formed using overlapping, parallel beams. Above the substrate 330, a first long beam can be positioned above and intersecting with a second long beam. One of the long beams can have blocks extending upward from it while the other long beam has holes slightly larger than the block size, through which the blocks can be disposed. Thus, using just two beams, the surface topologies of FIGS. 8 and 9A-9E are possible.

The diffraction grating 300 is capable of diffracting light in a direction parallel to a row, perpendicular to a row, and both parallel and perpendicular to a row, depending on which blocks are actuated. Put another way, from a top view of the diffraction grating 300 (as in FIGS. 9A-9E), diffraction in the horizontal direction, the vertical direction, and simultaneously in both the vertical and horizontal directions can be achieved.

Recall that diffraction is possible when alternating surfaces are simultaneously adjacent to, offset from, and parallel to one another. Some of the square wells 320 in FIG. 8 satisfy this limitation. However, the square wells 320 formed in the corner of the diffraction grating 300 are not diffractive because they lack an alternating surface in each direction. Likewise, the square wells 320 formed on side edges of the diffraction grating are not diffractive in both directions.

In FIGS. 9A-9E, the diffraction grating 300 is shown in various diffractive states. Horizontal and vertical arrows in each figure depict the direction of diffraction. Darkened shading indicates which blocks 310 are recessed toward the substrate to form square wells. In FIG. 9A, blocks 310B and 310C are actuated while blocks 310A and 310D are not recessed. With the exception of the square wells formed at the corners and the side edges, the square wells 320 formed in FIG. 9A are capable of diffracting in both a horizontal and a vertical direction. The diffraction grating 300 may also achieve both horizontal and vertical diffraction by actuating blocks 310A and 310D while not actuating blocks 310B and 310C.

As another possibility, alternating rows of blocks may be actuated in the diffraction grating 300. For example, in FIG. 9B, blocks 310C and 310D, an entire row of the diffraction grating, are actuated, while blocks 310A and 310B are not actuated. In this instance, the diffraction occurs in a vertical direction, i.e. in a direction perpendicular to the rows. To achieve a similar effect, blocks 310A and 310B may be actuated, while blocks 310C and 310D are not actuated.

In FIG. 9C, alternating columns of the diffraction grating 300 are actuated, such that diffraction occurs in a horizontal direction. Blocks 310A and 310C are actuated while blocks 310B and 310D are not actuated. As another option, blocks 310B and 310D may be actuated, while blocks 310A and 310C are not actuated, also resulting in horizontal diffraction.

As yet another option, a single block 310 in a 2×2 group may be actuated. In the diffraction grating 300 of FIG. 9D, blocks 310C are actuated, while blocks 310A, 310B, and 310D are not actuated. The diffraction occurs in both the horizontal and vertical directions. However, the diffraction is less efficient, relative to the above scenarios.

In FIG. 9E, three blocks of a 2×2 group are actuated. For example, blocks 310A, 310B and 310C are actuated, while block 310D are not actuated. Again, the diffraction occurs in both the horizontal and vertical directions. Like its functional equivalent (FIG. 9D), the diffraction is less efficient than for the scenarios of FIGS. 9A-9C. The examples depicted in FIGS. 9A-9E are but a few of the many possible arrangements of the blocks 310 of the diffraction grating 300. The versatility of the diffraction grating 300 may make it suitable for a number of different applications.

The diffraction gratings 100, 200, and 300 may be useful for a variety of applications, including, but not limited to, display systems, high-speed printing, maskless photolithography, optical filtering, optical networking, and variable optical attenuators and switches. Further, the diffraction gratings 100, 200, and 300 may be used in monochromator mountings, such as Czerny-Turner and Ebert-Fastie mountings. Monochromator mountings may use the diffraction gratings as an imaging surface whose diffracted rays can be projected onto a screen without loss of half of the diffracted light.

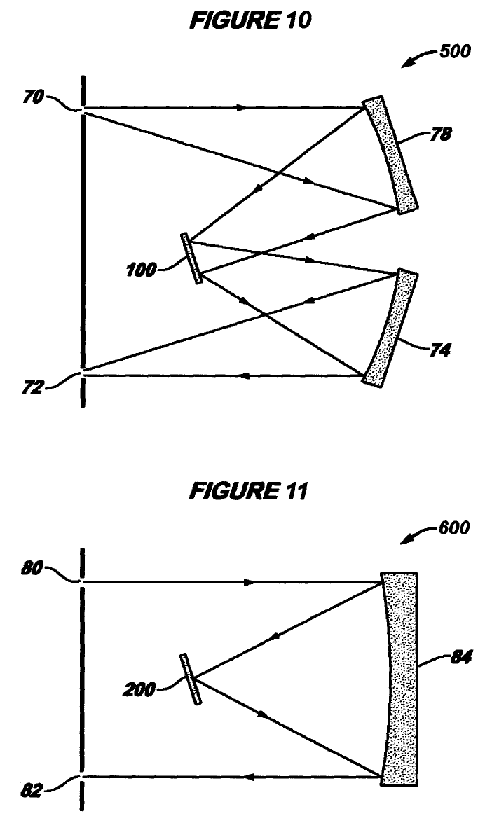

A Czerny-Turner monochromator 500, as depicted in FIG. 10, has two concave mirrors 74 and 78, usually placed near one another, and the diffraction grating 100, disposed at an angle. (Diffraction gratings 200 or 300, described above, can be substituted for the grating 100.) Incoming light travels through an entrance slit 70 and is reflected by a first concave mirror 78 (collimator) to the grating. The grating diffracts the light toward a second concave mirror 74 (camera), which reflects the diffracted light through an exit slit 72. The grating disperses the light and the mirrors focus the light.

An Ebert-Fastie monochromator 600, as depicted in FIG. 11, includes a large concave mirror 84 and the diffraction grating 200, set at an angle, to disperse the light. (Diffraction gratings 100 or 300 could also be used in the monochromator 600.) Light enters through an entrance slit 80 and strikes a side of the concave mirror 84 nearest the slit. The light reflects from the mirror to the grating, which diffracts the light to a second side of the mirror 84, which is then reflected through the exit slit 82. The mirror 84 serves as both the collimator and the camera of the monochromator 600. The Czerny-Turner and Ebert-Fastie monochromator are but two of many different applications for the diffraction gratings 100, 200, and 300.

In addition to being suited for monochromator mountings, the diffraction gratings 100, 200, and 300 are preferable over the prior art because the pitch of the square wells (distance between pixels) is user variable and is not dependent upon beam pitch. Some prior art diffraction gratings, in contrast, typically use four to six beams per pixel. Increasing the beam width improves the light capacity of the diffraction grating, slows down the beams slightly, and may also reduce speckle. Reducing the beam widths decreases the cost of the diffraction grating.

Although they may be either digital or analog, the diffraction gratings 100, 200, and 300 are preferably analog. The physical properties of the diffraction gratings 100, 200, and 300 can be adjusted, as desired, for a variety of applications. Beam or block size, well depth, pixel size, and other physical properties can be modified to meet the frequency, speed, bandwidth, efficiency and other features of the particular application.

While the invention has been described with respect to a limited number of embodiments, those skilled in the art will appreciate numerous modifications and variations therefrom. It is intended that the appended claims cover all such modifications and variations as fall within the true spirit and scope of the invention.

1. A diffraction grating, comprising:
a movable component, comprising a plurality of cross beams coupled to two long beams, wherein the two long beams are parallel to one another; and
a stationary component, comprising a plurality of projecting beams,
wherein the cross beams are alternately disposed between the projecting beams;
wherein a plurality of square wells are formed when the movable component is actuated and diffraction parallel to the long beams occurs when light strikes the square wells.

2. The diffraction grating of claim 1, wherein the plurality of cross beams are coupled between the two long beams.

3. The diffraction grating of claim 1, further comprising:
a base piece for coupling the plurality of projecting beams.

4. The diffraction grating of claim 1, the projecting beams comprising a first surface and the cross beams comprising a second surface, wherein the first and second surfaces comprise a substantially planar surface when the movable component is not actuated.

5. The diffraction grating of claim 4, wherein the first surface comprises a reflective surface.

6. The diffraction grating of claim 4, wherein the second surface comprises a reflective surface.

7. The diffraction grating of claim 1, the plurality of square wells further comprising:
a first square well having a first dimension;
a second square well having a second dimension, wherein the second dimension is smaller than the first dimension; and
a third square well having a third dimension, wherein the third dimension is smaller than the second dimension;
wherein the first square well diffracts light of a first wavelength, the second square well diffracts light of a second wavelength, and the third square well diffracts light of a third wavelength.

8. The diffraction grating of claim 7, wherein the first wavelength is the wavelength of red light.

9. The diffraction grating of claim 8, wherein the second wavelength is the wavelength of green light.

10. The diffraction grating of claim 9, wherein the third wavelength is the wavelength of blue light.

11. A diffraction grating, comprising:
a movable component, comprising a plurality of cross beams coupled to two long beams, wherein the two long beams are parallel to one another; and
a stationary component, comprising a plurality of projecting beams,
wherein the cross beams are alternately disposed between the projecting beams;
wherein a plurality of square wells are formed when the movable component is not actuated and diffraction parallel to the long beams occurs when light strikes the square wells.

12. The diffraction grating of claim 11, the projecting beams comprising a first surface and the cross beams comprising a second surface, wherein the first and second surfaces comprise a substantially planar surface when the movable component is actuated.

13. A diffraction grating, comprising:
a movable component, comprising a plurality of projecting beams coupled to one or more long beams; and
a stationary component, comprising a plurality of stationary beams,
wherein the projecting beams are alternately disposed between the stationary beams;
wherein a plurality of square wells are formed when the movable component is actuated such that diffraction parallel to the long beam occurs when light strikes the square wells.

14. The diffraction grating of claim 13, the projecting beams comprising a first surface and the stationary beams comprising a second surface, wherein the first and second surfaces comprise a substantially planar surface when the movable component is not actuated.

15. The diffraction grating of claim 14, wherein the first surface comprises a reflective surface.

16. The diffractive grating of claim 14, wherein the second surface comprises a reflective surface.

17. The diffraction grating of claim 13, the plurality of square wells further comprising:
a first square well having a first dimension;
a second square well having a second dimension, wherein the second dimension is smaller than the first dimension; and
a third square well having a third dimension, wherein the third dimension is smaller than the second dimension;
wherein the first square well diffracts light of a first wavelength, the second square well diffracts light of a second wavelength, and the third square well diffracts light of a third wavelength.

18. The diffraction grating of claim 17, wherein the first wavelength is the wavelength of red light.

19. The diffraction grating of claim 18, wherein the second wavelength is the wavelength of green light.

20. The diffraction grating of claim 19, wherein the third wavelength is the wavelength of blue light.

21. A diffraction grating, comprising:
a movable component, comprising a plurality of projecting beams coupled to one or more long beams; and
a stationary component, comprising a plurality of stationary beams,
wherein the projecting beams are alternately disposed between the stationary beams;
wherein a plurality of square wells are formed when the movable component is not actuated such that diffraction parallel to the long beam occurs when light strikes the square wells.

22. The diffraction grating of claim 21, the projecting beams comprising a first surface and the stationary beams comprising a second surface, wherein the first and second surfaces comprise a substantially planar surface when the movable component is actuated.

23. A diffraction grating, comprising:
a means for moving a plurality of movable beams between a plurality of stationary beams, wherein the plurality of movable beams are coupled to one or more long beams, and the plurality of movable beams are alternately disposed between the stationary beams;
wherein a plurality of square wells are formed when the plurality of movable beams are actuated, wherein diffraction parallel to the one or more long beams occurs when light strikes the square wells.

24. The diffraction grating of claim 23, further comprising:
a means for coupling the plurality of stationary beams.

25. The diffractive grating of claim 24, further comprising:
a means for actuating the movable component.

26. The diffraction grating of claim 25, the movable beams comprising a first surface and the stationary beams comprising a second surface, wherein the first and second surfaces comprise a substantially planar surface when the diffraction grating is not actuated.

27. The diffraction grating of claim 26, further comprising:
a means for reflecting light off the first and second surfaces.

28. A diffractive grating, comprising:
a plurality of blocks arranged in a row, the row being disposed atop a substrate, wherein each of the plurality of blocks can be independently moved toward or away from the substrate;
wherein a plurality of square wells are formed when selected blocks are moved such that diffraction occurs when light strikes the square wells.

29. The diffraction grating of claim 28, wherein the selected blocks are alternating blocks in the row.

30. The diffraction grating of claim 28, wherein the diffraction occurs in a direction parallel to the row.

31. The diffraction grating of claim 28, wherein the square wells are formed when selected blocks are moved toward the substrate.

32. The diffraction grating of claim 28, wherein the square wells are formed when selected blocks are moved away from the substrate.

33. The diffraction grating of claim 28, further comprising an array comprising a plurality of rows.

34. The diffraction grating of claim 33, wherein diffraction occurs in a direction perpendicular to the plurality of rows.

35. The diffraction grating of claim 33, wherein the diffraction occurs in a direction perpendicular to the plurality of rows and in a direction parallel to the plurality of rows.

36. The diffraction grating of claim 33, wherein the diffraction occurs simultaneously in a direction perpendicular to the plurality of rows and in a direction parallel to the plurality of rows.

37. The diffraction grating of claim 28, wherein the blocks are arranged in a plurality of adjacent groups, each group including a first group row and a second group row, wherein a first block and a second block occupy the first group row and a third block and a fourth block occupy the second group row.

38. The diffraction grating of claim 37, wherein the second block and the third block are actuated while the first block and the fourth block are not actuated, wherein diffraction occurs both perpendicular and parallel to the row.

39. The diffraction grating of claim 37, wherein the first block and the fourth block are actuated while the second block and the third block are not actuated, wherein diffraction occurs both perpendicular and parallel to the row.

40. The diffraction grating of claim 37, wherein the third block and the fourth block are actuated while the first block and the second block are not actuated, wherein diffraction occurs perpendicular to the row.

41. The diffraction grating of claim 37, wherein the first block and the second block are actuated while the third block and the fourth block are not actuated, wherein the diffraction occurs perpendicular to the row.

42. The diffraction grating of claim 37, wherein the first block and the third block are actuated while the second block and the fourth block are not actuated, wherein the diffraction occurs parallel to the row.

43. The diffraction grating of claim 37, wherein the second block and the fourth block are actuated while the first block and the third block are not actuated, wherein the diffraction occurs parallel to the row.

44. The diffraction grating of claim 37, wherein one block of an adjacent group is actuated while remaining blocks of the adjacent group are not actuated, wherein the diffraction occurs both perpendicular and parallel to the row.

45. The diffraction grating of claim 37, wherein one block of an adjacent group is not actuated while remaining blocks of the adjacent group are actuated, wherein the diffraction occurs both perpendicular and parallel to the row.

46. A method, comprising:
disposing a movable component against a stationary component, wherein the movable component comprises a plurality of cross beams coupled to at least one long beam and the stationary component comprises a plurality of projecting beams; and
actuating the movable component to a plurality of square wells, wherein diffraction parallel to the at least one long beam occurs when light strikes the square wells.

47. The method of claim 46, further comprising:
coating the movable component and the stationary component with a reflective material such that a substantially reflective surface is formed when the movable component is not actuated.

48. A method, comprising:
disposing a plurality of blocks in an array, the array comprising a plurality of rows, wherein each block can be independently actuated;
actuating one or more blocks such that a plurality of square wells are formed, wherein diffraction occurs when light strikes the plurality of square wells.

49. The method of claim 48, further comprising:
actuating a first selection of the plurality of blocks such that diffraction occurs in a direction parallel to the plurality of rows.

50. The method of claim 48, further comprising:
actuating a second selection of the plurality of blocks such that diffraction occurs in a direction perpendicular to the plurality of rows.

51. The method of claim 48, further comprising:
actuating a third selection of the plurality of blocks such that diffraction occurs in a direction both parallel and perpendicular to the plurality of rows.

52. A monochromator, comprising:
a first mirror for receiving light from a first slit;
a second mirror for reflecting light to a second slit; and
a grating for receiving light from the first mirror and reflecting light to the second mirror, wherein the grating comprises:
a movable component, comprising a plurality of cross beams coupled to two long beams, wherein the two long beams are parallel to one another; and
a stationary component, comprising a plurality of projecting beams,
wherein the cross beams are alternately disposed between the projecting beams;
wherein a plurality of square wells are formed when the movable component is actuated and diffraction parallel to the long beams occurs when light strikes the square wells.

53. The monochromator of claim 52, wherein the grating further comprises a reflective coating.

54. A monochromator, comprising:
a concave mirror having a first reflective surface and a second reflective surface; and
a grating, comprising a plurality of blocks in a row, wherein each of the plurality of blocks can be independently actuated such that a plurality of square wells are formed for diffracting light;
wherein light received by the monochromator is reflected off the first reflective surface to the grating, then diffracted to the second surface.

55. The monochromator of claim 54, wherein the grating is further coated with a reflective material.
